(19) United States
(12) Patent Application Publication
(10) Pub. No.: US 2010/0058641 A1
(43) Pub. Date: Mar. 11, 2010

(54) Fishing bobber device

(76) Inventor: Bruce R. Lee, Rappahannock Academy, VA (US)

Correspondence Address: Klima Law Offices, P.L.L.C., P. O. Box 780, Garrisonville, VA, 22463, US

(21) Appl. No.: 11/898,567

(22) Filed: Sep. 13, 2007

Related U.S. Application Data
(63) Continuation-in-part of application No. 11/812,681, filed on Jun. 20, 2007.

(51) Int. Cl. A01K 91/08; A01K 97/12

(52) U.S. Cl. 43/17; 43/43.13

(57) ABSTRACT

A fishing bobber device including an elongated float portion for exerting a sideways directional force on a fishing line, for example, during trolling or fishing moving water.

### CONTINUING INFORMATION

This application is a continuation-in-part (CIP) of U.S. patent application entitled “Fishing Bobber Device”, Ser. No. 11/812,681, filed Jun. 20, 2007, now pending.

### FIELD OF THE INVENTION

The present invention is directed to a fishing bobber device, in particular a directional fishing bobber device configured to exert or impart a directional force on a fishing line, for example, configured to move the fishing line sideways away from the back side of a boat while trolling.

### BACKGROUND OF THE INVENTION

A conventional fishing bobber or float is made of a plastic outer shell to provide a hollow interior. The interior is sealed to trap air inside the bobber to make the fishing bobber buoyant. The conventional fishing bobber can be releaseably connected to a fishing line so that the depth of the hook and bait can be adjusted.

The conventional fishing bobber only exerts an upwardly directed buoyancy force on the portion of the fishing line located below the water and attached to a sinker and hook. Further, the conventional fishing bobber is used mostly for fresh water fishing in calm inland waters (e.g. ponds, lakes, rivers, reservoirs). The conventional fishing bobber only provides buoyancy, for example, to the tackle (e.g. hook, bait, sinker). The conventional fishing bobber cannot exert or impart any sidewise directional force on the fishing line, except for a possible drag force, if the fishing line is being moved through the water, for example, during trolling off a boat.

For many types of trolling, where a person is using a fishing pole having a fishing line, a fishing bobber is not used at all since the depth of the hook and bait can readily be adjusted by bringing in or letting out the fishing line with the reel of the fishing pole. Various types of tackle can be attached to the end of the fishing line, for example, a single lure (e.g. spoon), multiple lures, rig (e.g. umbrella), or other type of tackle suitable for trolling for fish. Again, it is unusual to utilize a conventional fishing bobber while trolling.

A problem encountered while trolling for fish is that it is desirable to have multiple fishing poles each having a fishing line in the water at the same time. For example, many fishermen use two fishing poles off the sides or corners of the boat positioned as outriggers and an optional center fishing pole to allow at least three fishing lines in the water at the same time while trolling. However, when the lines get too close together and/or the fishing tackle moves (e.g. due to drag) or spins when operating in the water, there exists a likelihood of the fishing lines be tangled, especially when the boat is making a turn (especially a tight turn) and/or when a plurality of fish get on the fishing lines at the same time, again causing the lines to then move sideways, spin and then tangle. It is desirable to maintain or increase the distance between multiple fishing lines in the water at the same time during trolling. For example, moving the outer fishing pole lines further outwardly sideways from the sides of the boat while trolling would greatly decrease the chance or possibility of the fishing lines tangling with the center fishing line. Further, when multiple boats are trolling side-by-side, or adjacent on parallel courses near a school of fish and/or an underwater formation (e.g. scholl, rocks, piles, wrecks) it is desirable for the boats further away from the fish school or the underwater formation to move their fishing lines further sideways from their boats towards where the fishing action is taking place while not disturbing or encountering the other boats fishing in the same vicinity.

There also exists fishing situations in which the fisherman is stationary (e.g. standing on beach, standing on a water's edge, or standing in shallow water) while fishing in moving water (e.g. tide, current or flow of water, for example, in a stream, river, ocean, inlet to ocean). In some instances, it is desirable that the fishing line can be moved closer or away from the beach or water's edge to place the fishing tackle in a better location for increased fishing action.

The fishing bobber device of the present invention is configured to exert or impart a directional force on the fishing line when the fishing line is in relatively moving water (e.g. while trolling, fishing in a current). The movement of water relative to the fishing bobber according to the present invention will exert or impart a sideways directional force on the fishing bobber device according to the present invention, which in turn will exert or impart a sideways directional force on the fishing line connected to the fishing bobber device according to the present invention. The directionality of the directional force exerted by the fishing bobber device according to the present invention on the fishing line can be reversed depending on the orientation of the fishing bobber according to the present invention on the fishing line.

### SUMMARY OF THE INVENTION

A first object of the present invention is to provide an improved fishing bobber device.

A second object of the present invention is to provide a directional fishing bobber device configured to exert or impart a directional force on a fishing line.

A third object of the present invention is to provide a fishing bobber device configured to exert or impart a sideways directional force on a fishing line.

A fourth object of the present invention is to provide a fishing bobber device having a simple construction.

A fifth object of the present invention is to provide a fishing bobber device including a float portion.

A sixth object of the present invention is to provide a fishing bobber device having a float portion connected to a fin portion.

A seventh object of the present invention is to provide a fishing bobber device having a float portion connected to a blade portion.

An eighth object of the present invention is to provide a fishing bobber device having a float portion in combination with a portion or feature for exerting or imparting a directional force on the float when the fishing bobber device encounters moving water.

A ninth object of the present invention is to provide a fishing bobber device having an elongated float portion and no fin portion.

A tenth object of the present invention is to provide a fishing bobber device having an elongated float portion that provides a directional force on the fishing bobber device.

An eleventh object of the present invention is to provide a fishing bobber device having an elongated float portion and at least one passageway through and across the width of the elongated float portion to accommodate the fishing line.

A twelfth object of the present invention is to provide a fishing bobber device having an elongated float portion and at least one transverse passageway through and across the width of the elongated float portion to accommodate the fishing line.

A thirteenth object of the present invention is to provide a fishing bobber device having an elongated float portion and a plurality of passageways through the width of the elongated float portion at different positions along the length thereof to accommodate the fishing line.

A fourteenth object of the present invention is to provide a fishing bobber device having an elongated float portion and a plurality of transverse passageways through the width of the elongated float portion at different positions along the length thereof to accommodate the fishing line.

A fifteenth object of the present invention is to provide a fishing bobber device configured to provide a torsion force on the fishing bobber device when the fishing bobber is operating in water moving relative to the fishing bobber device.

A sixteenth object of the present invention is to provide a fishing bobber device configured so that the fishing line exerts a torsion force on the fishing bobber device during operation of the fishing bobber device.

A seventeenth object of the present invention is to provide a fishing bobber device having an elongated float portion and at least one passageway across the width of the elongated float portion for accommodating the fishing line, said at least one passageway configured and orientated so that said fishing line exerts a torsion force on said elongated float portion.

The present invention is directed to an improved fishing bobber device. The fishing bobber device connects, preferably releasably connects, to a fishing line. A preferred embodiment of the fishing bobber device according to the present invention can exert or impart a directional force, preferably a sideways directional force, on the fishing line during use. For example, the preferred embodiment of the fishing bobber device according to the present invention is configured so that “moving water” (i.e. water moving relative to the fishing bobber device, e.g. fishing bobber device moving relative to standing water, fishing bobber device being held stationary while exposed to moving water, or both water and fishing bobber device moving at differential velocity). In any event, in the preferred embodiment of the fishing bobber device according to the present invention, the water exerts or imparts a directional force on the fishing bobber device, which in turn the fishing bobber device then exerts or imparts a force on the fishing line connected thereto. An important feature of the preferred embodiment of the fishing bobber device according to the present invention is the ability to move the fishing line directionally, preferably sideways, to a position or location it would not normally occupy due to the existence of the fishing bobber device. Further, the preferred embodiment of the fishing bobber device according to the present invention provides a predictable directionality of movement of the fishing line during use of the fishing bobber device so that the fisherman can selectively place the fishing line at a desired location. Thus, a fisherman can utilize the preferred embodiment of the fishing bobber device according to the present invention to position or locate the fishing line at a particular desired location such as a school of fish, an under water formation, or fish jumping a water surface to increase the likelihood of catching fish.

A preferred embodiment of the fishing bobber device according to the present invention includes a float portion connected to a portion, part, feature or device that can exert of impart a force on the float portion. For example, the portion, part, feature or device can exert or impart a directional force (e.g. translational force) on the float portion of the fishing bobber device. In a most preferred embodiment of the fishing bobber device according to the present invention, the float portion is connected to at least one fin or blade, which fin or blade exerts or imparts a directional force on the float portion when the fishing bobber device is exposed or floating in moving water. Preferably, the at least fin or blade is directly connected to float portion. Alternatively, the float portion can be configured (e.g. elongated float portion) so that the float portion itself exerts or imparts a directional force on the fishing line with or without the addition of a fin or blade portion. Specifically, for example, the float portion can be an elongated float portion so that the length of the elongated float portion contacting the water's surface functions or acts as a fin or blade to provide a directional force. The elongated float portion can be, for example, an elongated cylinder or rod shaped, boat shaped, canoe shaped, sub shaped, catamaran shaped, tri-hull shaped or other suitable shape capable of cutting or catching the surface of the water. As a further alternative, the float portion is made (e.g. molded) is provided with a contoured bottom generate a directional force during operation (e.g. bottom molded with one or more fins, blades, keels, or other directional surfaces (i.e. surface or surface portion capable of generating a directional force).

In one particularly preferred embodiment of the fishing bobber device according to the present invention, the float portion is made of foam material, or alternatively or in combination, is a hollow plastic object (e.g. blow molded, injection molded) to provide buoyancy to the fishing bobber device. For example, the float portion is a molded Styrofoam article (e.g. body), for example, having an elliptical or elongated shaped side profile and a round or elongated shaped top and bottom profile to provide an elongated float portion.

A preferred embodiment of the fin or blade portion is a flat elongated fin or blade connected to the float portion. For example, a slot can be molded or cut into the Styrofoam float, and the fin or blade can then be received within the slot in the Styrofoam float. The fin or blade can be connected by an interference fit and/or adhesive and/or mechanical fastener or connector to the float portion. The fin or blade can be made of wood, plastic, foam, rubber, metal, fiberglass, graphite, Kevlar, Plexiglas, ABS, PVC, polyethylene, polypropylene, composite, or some other suitable material.

In a preferred embodiment, the fin or blade is preferably connected at an inclined angle relative to a central axis of the rotating hub portion. Further, the fin or blade is connected to one side of the float portion. For example, one elongated edge of the fin or blade intersects with a center axis of the float portion, and the opposite elongated edge of the fin or blade is located outside the periphery of the float portion. The fin or blade can be flat, curved, or shaped to impart a desired directional force to the float portion. The combination of the float portion and the fin or blade portion acts as a water ski when the fishing bobber device is floating and moving on the surface of the water.

The fishing bobber device according to the present invention is connected to the fishing line during use. For example, the fishing line in connected to only the float portion, connected to only the blade portion, or connected to both the float portion and blade portion. For example, the float portion and/or blade portion are each provided with at least one passageway for accommodating the fishing line. For example, a passageway extends from a center of the upper end of the float portion at an angle to the location of the blade portion, and then passes out through a hole in the center of the blade portion. The fishing line is treaded through the passageway in the float portion and hole in the blade portion during assembly of the fishing rig. Preferably, at least one guide or a plurality of guides (e.g. plastic tube sections) are provided in the passageway to accommodate the fishing line. The guide(s) reinforce the float portion, when made of soft material such as Styrofoam, so that the fishing line does not damage, distort, compress, cut, and wear through or otherwise compromise the passageway through the float portion.

In a preferred embodiment, the fishing bobber device is an elongated float or float portion. The elongated float or float portion is provided with at least one passageway through and across the width of the elongated float or float portion for accommodating the fishing line. Preferably, the elongated float or float portion is provided with a plurality of passageways through and across the width of the elongated float or float portion at different locations or positions along the length of the elongated float or float portion. This allows the fisherman to selectively thread the fishing line through a particular passageway to select the amount or degree of directional force to be exerted by the fishing bobber device on the fishing line. Specifically, moving the fishing line to a different passageway changes the angle of incidence relative to the direction of movement of the fishing bobber device with the surface of the water varying the degree of directional force generated by the fishing bobber device. Thus, this configuration allows the fisherman to select the degree of directional force by selecting a particular passageway for accommodating the fishing line.

The at least one passageway through the elongated float or float portion is preferably oriented transversely relative to the length of the elongated float or float portion. This orientation generates a torsion force on the fishing bobber device, which can be configured to increase or decrease the angle of incidence of the fishing bobber device relative to the direction of movement of the fishing bobber device increasing or decreasing the directional force. Alternatively, the passageway can be oriented at an angle relative to the length axis of the fishing bobber device to increase or decrease or even eliminate the torsion force applied by the fishing line on the fishing bobber device.

The at least one passageway is preferably provided with a guide (e.g. plastic tube section) to reinforce the wall of the passageway. For example, a hole is provided through the float or float portion, and then a plastic tube section having an outer diameter similar, preferably slightly larger, than the inner diameter of the hole is inserted into the hole. The plastic tube section can be anchored within the hole using adhesive, interference fit, anchoring structure (e.g. surface protrusions), to maintain the plastic tube section within the hole during use and life of the fishing bobber device. In a preferred embodiment, a line stop is used in combination with the passageway or plastic tube section to releasably secure the fishing bobber to the fishing line. For example, the line stop is a plastic plug having a hole there through for accommodating the fishing line. The fisherman makes a loop in the fishing line between the removed plug and the plastic tube section, and then inserts the plastic plug into the end of the plastic tube section to catch the loop of fishing line between the plastic plug and the plastic tube section to set the fishing line on the fishing bobber device. This sets the depth of the hook relative to the fishing bobber device. When a fish is hooked, and the fisherman pulls on the fishing line with the fishing pole, the fishing line then pulls out the plastic plug from the plastic tube section to then allow both the plastic plug and fishing bobber device to freely move up and down on the fishing line so as to not interfere with the fishing line while catching the fish.

The fishing bobber device according to the present invention can be made as a one-piece unit, for example, by molding, or can be made of multiple pieces, parts or portions assembled together to make the completed unit.

### BRIEF DESCRIPTION OF THE DRAWINGS

FIG. 1 is bottom perspective view of a preferred embodiment of a fishing bobber device according to the present invention.

FIG. 2 is a bottom planar view of the fishing bobber device shown in FIG. 1.

FIG. 3 is a top planar view of the fishing bobber device shown in FIG. 1.

FIG. 4, is an upside down side elevational view of the fishing bobber device shown in FIG. 1.

FIG. 5 is a right side up elevational view of the fishing bobber device shown in FIG. 1.

FIG. 6 is an end elevational view of the fishing bobber device shown in FIG. 1.

FIG. 7 is an end elevational view of the fishing bobber device shown in FIG. 1.

FIG. 8 is a bottom planar view of an alternative embodiment of the fishing bobber device according to the present invention.

FIG. 9 is a bottom planar view of the fishing bobber device shown in FIG. 1, modified to include a weight on the center bottom of the blade portion.

FIG. 10 is a center cross-sectional view of the float portion 12 of the fishing bobber device 10 shown in FIG. 1, to illustrate the cooperation and operation of the guide and line lock of the float portion with the fishing line.

FIG. 11 is a diagrammatic aerial of a boat having three fishing rods in the water with the outside rods having the fishing bobber device according to the present invention in operation to directionally move the lines outwardly and sideways away from the sides of the boat.

FIG. 12 is bottom planar view of a further preferred embodiment of the fishing bobber device according to the present invention having an elongated float or float portion.

FIG. 13 is a side elevational view of the fishing bobber device shown in FIG. 12.

FIG. 14 is a side elevational view illustrating the operation of the fishing bobber device similar to the fishing bobber device shown in FIGS. 1 and 9, however, the passageway through the float portion is placed at a downward angle leading to a hole through the blade portion for accommodating the fishing line.

FIG. 15 is a diagrammatic top elevational view of the fishing bobber device shown in FIG. 14 during operation thereof.

FIG. 16 is a diagrammatic top elevational view of the fishing bobber device shown in FIGS. 12 and 13 during operation thereof.

FIG. 17 is a side elevational view of another further preferred embodiment of the fishing bobber device according to the present invention.

FIG. 18 is an end elevational view of the fishing bobber device shown in FIG. 17.

FIG. 19 is a side elevational view of the fishing bobber device shown in FIG. 17, modified to include a blade portion.

FIG. 20 is an end elevational view of the fishing bobber device shown in FIG. 19.

FIG. 21 are three (3) diagrammatical sequence perspective views of the assembly and disassembly of the line stop.

FIG. 22 is a side elevational view of an even further embodiment of the fishing bobber device according to the present invention.

FIG. 23 is a left end elevational view of the fishing bobber device shown in FIG. 22.

FIG. 24 is a right end elevational view of the fishing bobber device shown in FIG. 22.

FIG. 25 is a lengthwise central horizontal cross-sectional view of the fishing bobber, device, as indicated in FIG. 22.

FIG. 26 is a side elevational view of the fishing bobber device shown in FIG. 22 during operation.

FIG. 27 is a lengthwise horizontal central cross-sectional view of the fishing bobber device shown in FIG. 22 during operation, and showing a force diagram thereon.

### DETAILED DESCRIPTION OF PREFERRED EMBODIMENTS

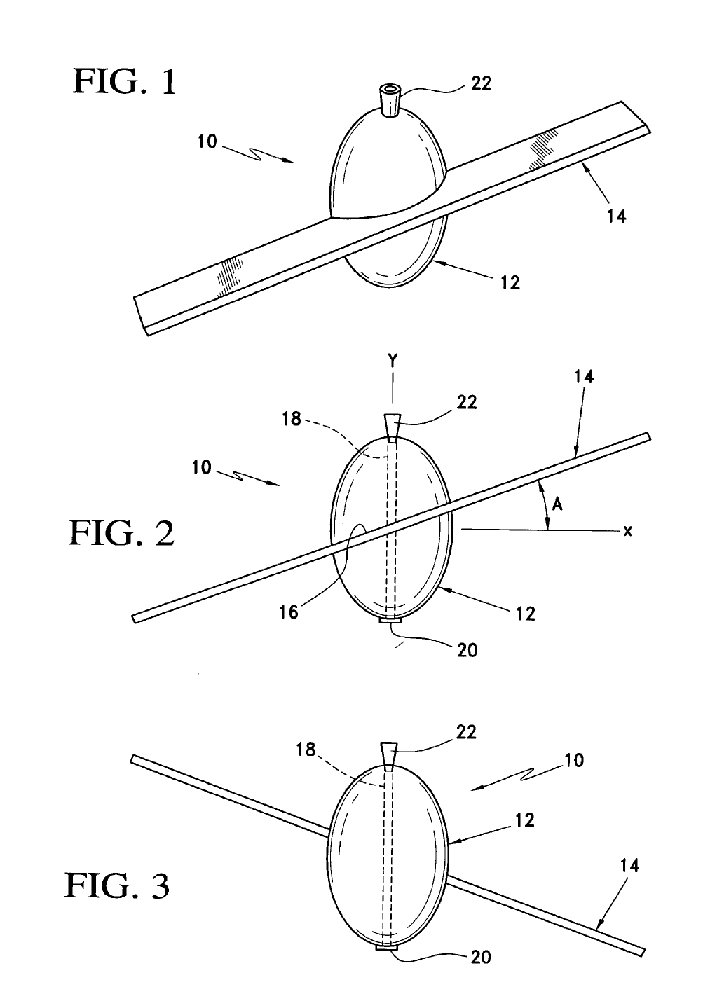

A preferred embodiment of the fishing bobber device 10 according to the present invention is shown in FIGS. 1-7.

The fishing bobber device 10 includes a float portion 12 and a blade portion 14. The float portion 12 can be constructed and/or made of a material to preferably provide positive buoyancy, however, other alternative embodiments may have neutral buoyancy, or negative buoyancy. A preferred embodiment of the float portion 12 is round or elliptical, and centered on the length of the blade portion 14. For example, the float portion 12 can be made of a Styrofoam material (e.g. molded or machined or hot-wired), or the float portion 12 can be a hollow plastic article or object (e.g. blow molded or plastic molded upper and lower portions joined and sealed together).

The blade portion 14 is shown in FIG. 1 as being an elongated rectangular parallelepiped shape having a uniform thickness and width. The blade portion 14, for example, can be made of plastic, wood, foam, fiberglass, graphite, cavler, composite or other suitable material, and preferably has negative buoyancy so that the blade sinks into the water, preferably at or below the surface of the water. Alternatively, the blade portion 14 can be replaced with one or more separate fins extending outwardly from the rotating hub portion 12. The blade portion 14, alternatively, can be shaped as an airfoil with a uniform width or downwardly tapering width from the connection with the float portion 12 to the tip of the blade portion 14. The float portion 12 and/or the blade portion 14 are configured so that the fishing bobber device 10 acts or performs as a water ski on the surface of the water to provide a directional, preferably a sideways direction force on the fishing line to which it is attached.

The fishing bobber device 10 can be made as a single piece (e.g. plastic molded one piece unit), for example, by injection molding, or can be made as separate pieces assembled together. For example, the float portion 12 is a molded Styrofoam float, and the blade portion 14 is a one-piece plastic or wood blade. A slot 16 (FIG. 2) can be provided in the side of the float portion 12, for example, by molding and/or cutting, and a center edge of the blade portion 14 is received within the slot 16. The connection between the float portion 12 and the blade portion 14 can be provided by an interference fit and/or an adhesive and/or a mechanical fastener between the blade portion 14 and float portion 12 to securely connect the blade portion 14 to the float portion 12. In some embodiments, the blade portion 14 is removably connected to the float portion 14, for example, for replacement, to change out a different blade, and/or to change the orientation when connected to the float portion 12.

A through passageway 18 is provided in the float portion to accommodate a fishing line 19 (FIG. 10). The passageway 18 can be provided by molding and/or machining (e.g. drilling) the rotating hub portion 12. The passageway 18 is preferably located along a central axis of the float portion 12, however, the passageway 18 can be located off axis and/or inclined relative to the central axis shown, and/or can only partial extend through the float portion 12 (e.g. extend from the center end to the slot 16 accommodating the blade portion 14. The passageway 18 can be replaced with an alternative connector for attaching the fishing line to the fishing bobber device 12. For example, a set of swivels can be embedded in the float portion 12 at different locations for connection to the fishing line.

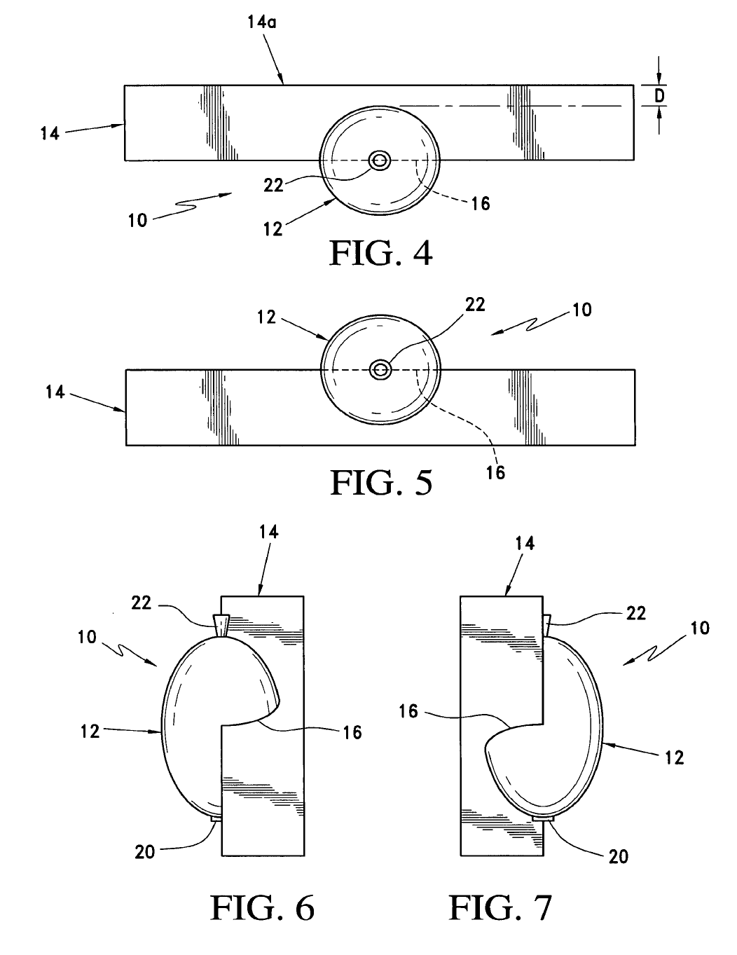

The blade portion 14 is shown as being inclined at an angle A (FIG. 2) relative to the central axis (Y-axis) of the float portion 12. The blade portion 14 is shown not tilted along its length, however, the blade portion 14 can also be tilted and/or twisted to enhance or decrease the angle of attack of leading edges of the blade portion during operation to increase or decrease the amount of directional force developed by the fishing bobber device 10. As shown in FIG. 4, the width of the blade portion 14 is greater than the radius of the float portion 12 so that a longitudinal edge 14a is located outside the periphery of the float portion 12. Specifically, the longitudinal edge 14a of the blade portion 14 extends outwardly a distance D from the periphery of the float portion 12. This arrangement enhances the directional force developed by the blade portion 14 applied to the float portion 12 by increasing the depth the blade portion 14 is located below the surface of the water. The width the blade portion and the depth of the slot 16 can be varied to tailor the directional force for a particular fishing application.

The passageway 18 is preferably provided with a guide 20 on the leader side of the fishing line 19 (FIG. 10) leading to the tackle (e.g. hook and sinker). The guide 20, for example, is made of a durable plastic (e.g. nylon, polyurethane, polyethylene, polypropylene) that protects the wall of passageway 16 at the one opening thereof. The guide 20 is optional for a float portion 12 made, for example, of harder plastic or wood material, however, is more important and may be required with softer materials for the float portion 12 such as Styrofoam, foam, balsa wood, rubber, and latex. A line lock 22, for example, is made of a durable plastic and is a tapered plug shaped part having a through hole in the center thereof As shown in FIG. 10, a loop 19b of the fishing line 19 is trapped between the wall of the passageway and the outer tapered surface of the line lock 22 to set or lock the fishing line 19 from movement relative to the fishing bobber device 10 to set the depth of the tackle. To change the length and depth of the fishing line 19 in the water relative to the fishing bobber device 10 to the tackle, the line lock 22 is pulled outwardly while twisting by the fishman's fingers to remove same from the end of the passageway 18. The positioning of the fishing bobber device 10 on the fishing line 19 is then adjusted. The loop 19b is again made at the location of applying the line lock 22, using the fisherman's fingers, and then the line lock 22 is reinserted into the end of the passageway 18 to wedge the line lock 22 into the end of the passageway 18, and again trap the looped portion 19a of the fishing line 19 between the inner wall of the passageway 18 and outer tapered surface of the line lock 22. This line lock 22 arrangement securely sets or locks the fishing line 19 to the float portion 12, and in turn sets or locks the fishing bobber device 10 on the fishing line 19.

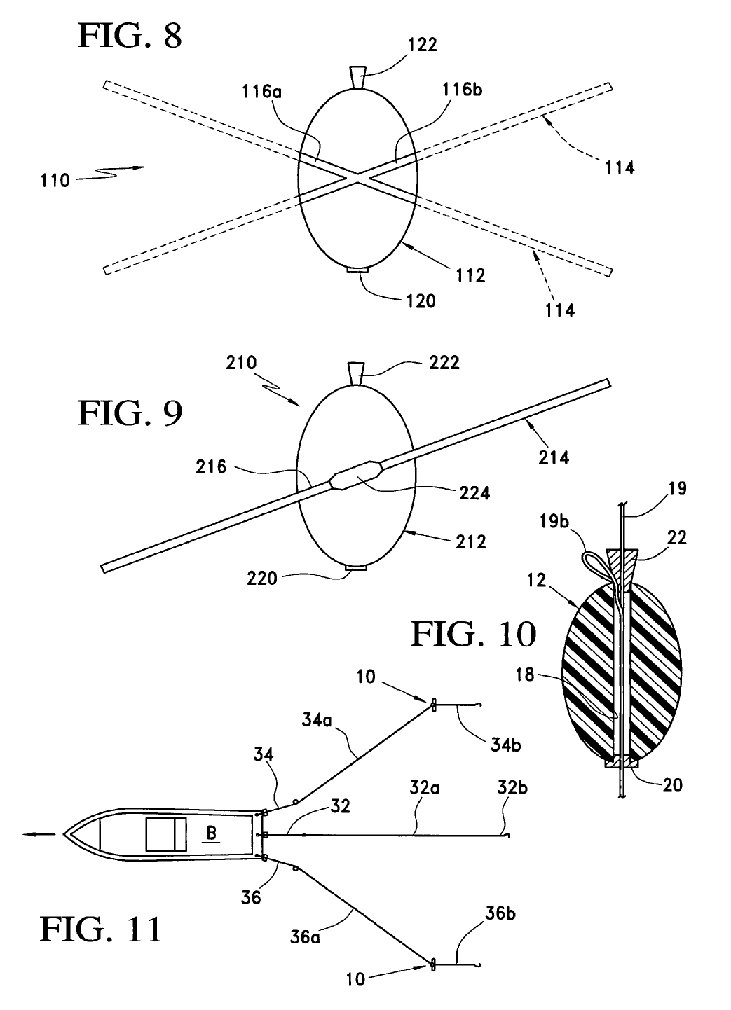

An alternative embodiment of the float portion 112 is shown in FIG. 8. The float portion 112 is provided with a pair of oppositely inclined slots 116a, 116b to allow the fishing bobber device 110 to be “reversible”. Specifically, the blade portion 14 is removable from the slots 116a, 116b of the float portion 112 to allow the blade portion 14 to be located in one of the slots 116a or 116b depending on the desired direction of applying the directional force from the fishing bobber device 10 to the fishing line 19. The blade portion 114, for example, can be moved from slot 116a to slot 116b to change the direction of the directional from to be the opposite (e.g. from left to right or from right to left) operating on the fishing line 19. Reversing the orientation of the blade portion 114 changes the directional force applied on the fishing line 19 by the fishing bobber device 110 by one hundred eighty degrees (180°) in the opposite direction.

Another embodiment of the fishing bobber device 210, is shown in FIG. 9. The fishing bobber device 210 is the same as the fishing bobber device 10, as shown in FIG. 1, however a weight 224 is added to the center of the bottom edge of the blade portion 214. The weight 224, for example, can be a lead fishing line weight connected by placing the slot of the weight over the lower edge of the blade portion 214, and then squeezing the weight to pinch the lower edge of the blade portion 214 to secure same thereon. The weight 222 tends to stabilize the fishing bobber device 210 during operation, by maintaining the blade portion 214 in the water, in particular at and below the surface of the water during operation, which maintains the directional force applied by the blade portion 214 onto the float portion 212, and in turn applied to the fishing line 19. Further, the weight 224 lowers the blade portion 214 in the water increasing the amount of directional force generated by the blade portion 214, for example, when needed in heavy waves and/or strong currents.

In operation, a fishing boat B as shown in FIG. 11, for example, can have three fishing poles 30, 32, 34 operating off the back of the fishing boat B. The center fishing pole 32 includes a fishing line 32a and tackle 32b, and is operating without the use of the fishing bobber device 10 according to the present invention. The fishing pole 34 having the fishing line 34a is provided with a fishing bobber device 10 according to the present invention along the length of the fishing line leading to the fishing tackle 34b. The fishing pole 36 having the fishing line 36a is provided with a fishing bobber device 10 according to the present invention along the length of the fishing line leading to a fishing tackle 36b.

The fishing line 32a extends straight back from the fishing boat B during trolling due to the drag on the fishing tackle 32b while the fishing lines 34a, 36a extend outwardly away from the sides of the boat, at an angle exceeding the angle of the fishing poles 34, 36 relative to the sides of the boat B. The fishing bobber devices 10, 10 increase the extent that the fishing lines 34a, 36a are moved away from the sides of the boat. The leader portions of the fishing lines 34a and 36a, that are connect to tackle 34b, 36b, respectively, then turn at an angle so that these leader portions again orient in the trolling direction of the boat B due to the drag on the fishing tackles 34b, 36b. Thus, the fishing bobber devices 10 effectively move the fishing lines 34a, 36a outwardly from the opposite sides of the boat B to maintain a greater distance between the fishing tackles 32b, 34b, 36b than would be obtainable without the fishing bobber devices 10, 10.

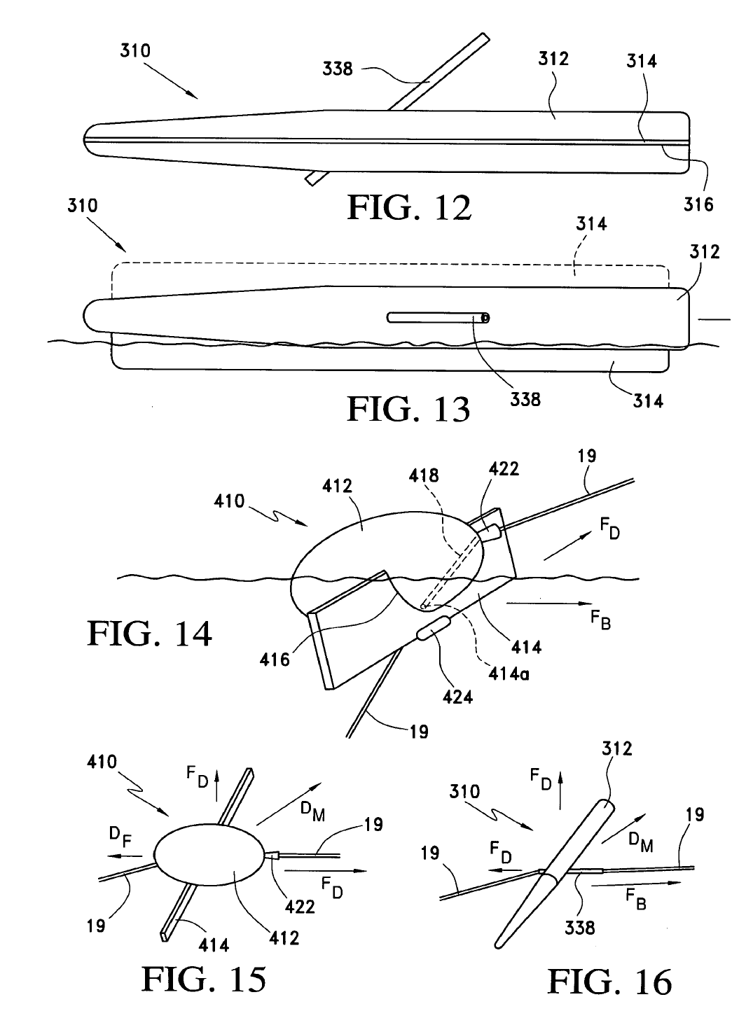

A further preferred embodiment of the fishing bobber device 310 according to the present invention is shown in FIGS. 12 and 13.

The fishing bobber device 310 includes an elongated float portion 312 connected to an optional blade portion 314. The elongated float portion 312 itself generates a directional force, and acts and performs as a blade or fin when being pulled at an angle while floating on the surface of the water due to a long line of contact with the surface of the water. The optional blade portion 314 enhances the amount of directional force generated.

The fishing bobber device 310 includes a tube 338 disposed at an angle as shown relative to a central longitudinal axis of the elongated float portion 310 for accommodating the fishing line 19. The fishing bobber device 310 can include a single removable blade 314 that can be disposed within a slot 316 provided on opposite sides of the elongated float portion 310 so as to be “reversible” for provide either a left or right sideways directional force. Alternatively, the fishing bobber device 310 can be provided with a pair of opposite blade portions 314, 314 to provide the “reversible” provision.

Another further preferred embodiment of the fishing bobber device 410 according to the present invention is shown in FIG. 14.

The fishing bobber device 410 includes a float portion 412 connected to a blade portion 414. The blade portion 414 is provided with a weight 424 at the center of the lower edge thereof. A float portion 412 is provided with a partial length inclined passageway 418 extending from one end of the float portion 412 ending inside the slot 416 in the float portion 412. The blade portion 414 is provided with a through hole 414a that communicates with the inner end of the passageway 418 ending in the slot 416 so that the fishing line 19 extends through the passageway 418 in the float portion 412 then into and through the through hole 414a in the blade portion 414 and then out of the slot 416 at a position trailing the blade portion 414.

In operation, as shown in FIG. 14, the fishing bobber device 410 self-orients itself in the water with the float portion 412 up and the blade portion 414 down in the water. Depending on a number of parameters, the blade portion 414 can be partially or fully submerged below the surface of the water during operation. The buoyant float portion 412 lifts the blade portion 414 upwardly so that the blade portion 414 does not sink due to its own weight or density, or the combined weight and density of the blade portion 414 and weight 424.

As shown in FIG. 15, the fishing bobber device 410 is towed by the boat in the direction of movement of the boat, which exerts a towing or pulling boat force FB on the fishing bobber device 410. When the fishing bobber device 410 is being towed, the blade portion 414 develops a sideways directional force F_{D}, causing the fishing bobber device 410 to move sideways. The combined forward and sideways forces exerted on the fishing bobber device 410 by the boat and the blade portion 414 causes the fishing bobber device 410 to move in the direction D_{M} against the drag force F_{D}. The fishing bobber device 410 will continue to move forward at the same speed as the boat, and will continued to move sideways until a steady state is achieved and the combined forces on the fishing bobber device 410 (i.e. towing force, sideways force generated by blade portion 414, and drag force) cause the fishing bobber device 410 to stop advancing sideways. Increasing the speed of the boat increases the amount of sideways force generated by the blade portion 414 causing the fishing bobber device 410 to move out further from the side of the boat until a steady state is again achieved.

In the embodiments shown in FIGS. 1-10 and 14 using a relatively small elliptical-shaped float portion, the float portion is shaped so as to not generate any sideways force on the fishing bobber device. Specifically, a round or elliptical shaped float portion will only generate a small drag force when being towed on the surface of the water. However, in the embodiment shown in FIGS. 12, 13 and 16, the elongated float portion 312 itself can generate a significant sideway force when towed at an angle relative to the towing direction. In some embodiments, the towing force is suitable to an extent that the blade portion(s) 314 are optional (e.g. can be removed). However, providing the blade portion(s) 314 significantly increases the amount of sideways force generated and provides an additive sideways force.

As shown in FIG. 16, the tube 338 aligns with the towing direction of the boat due to the boat towing force F_{B} acting on the fishing bobber device 310. The boat towing force F_{B} causes the elongated float portion 312 to be pulled at an angle relative to the towing direction generating a sideways directional force F_{D}. The combined forces F_{B} and F_{D} cause the fishing bobber device 310 to move in the direction D_{M} against the drag force F_{D}. Again, the fishing bobber device will continue to move outwardly away from the side of the boat until a steady state is reached, and the fishing bobber device 312 will top advancing sideways for a particular boat speed.

The operation described above involves towing of the fishing bobber device while trolling. Alternatively, the fishing bobber device can operate in other situations involving moving water relative to the fishing bobber device such as when fishing from a beach or water front along a stream, river or inlet. The relative movement of water of the fishing bobber device is essential for the fishing bobber device to generate a sideways directional force on the fishing line.

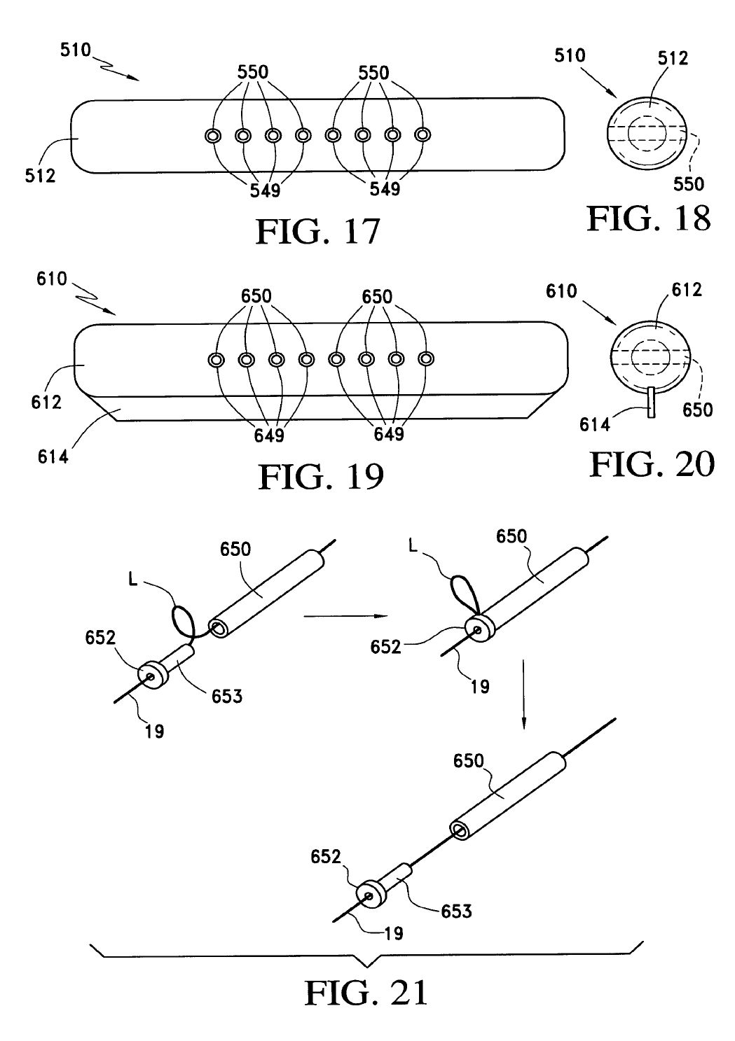

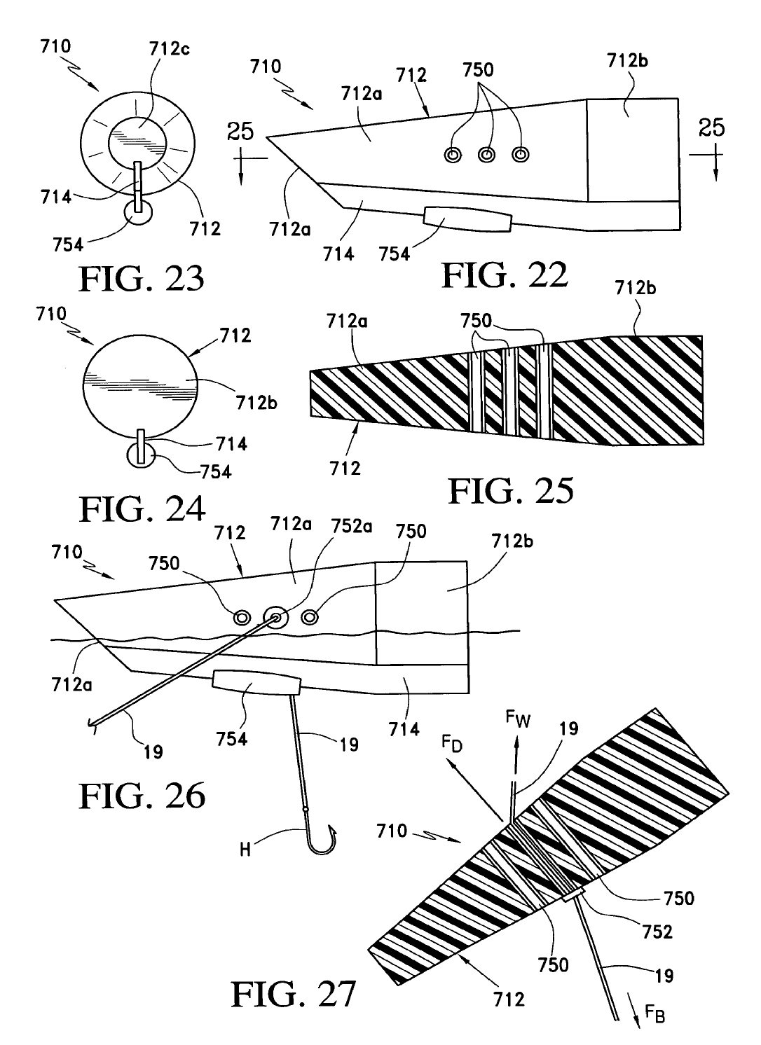

An even further preferred embodiment of the fishing bobber device 510 according to the present invention is shown in FIGS. 17 and 18.

The fishing bobber device 510 includes an elongated float portion 512. It is noted that this particular fishing bobber device 510 is not provided with a blade portion (see embodiment shown in FIG. 19), since the elongated configuration and substantial length of the elongated float portion 512 when contacting the surface of the water provides a directional force when moving relative to the surface of the water. The elongated float portion 512 is provided with a plurality of through passageways 549 fitted with tube sections 550 located at different locations along the length of the fishing bobber device 510. The tube sections 550, for example, can be made of plastic, fiberglass, metal or other suitable material that can be easily formed by machining, injection molding, extruding, or other suitable method. The tube sections 550 are approximately the same width of the blade portion 512 so as to provide an inlet and outlet for the fishing line. Specifically, the fishing line is threaded through one of the selected tube section 550. The tube sections 550 reinforce the through passageways 549, which prevents the fishing line from cutting into or otherwise damaging the through passageways 549, especially when the elongated float portion 512 is made of a soft material (e.g. Styrofoam).

The fishing bobber device 510 is provided with the plurality of tube sections 550 located at different positions along the length of the fishing bobber device 510 to provide some adjustment as to the amount of directional force exerted by the fishing bobber device 510 onto the fishing line. The left most tube section 550 provides the least directional force while the right most tube section 550 provides the greatest directional force when the fishing bobber device 510 is moving in a direction to the left of FIG. 17. Moving the location of the fishing line at the different tube sections 550 changes the angle of attack of the fishing bobber device 510 relative to the direction of movement of the fishing bobber device 510 on the surface of the water increasing or decreasing the amount of directional force depending on the location of the particular tube section 550 the fishing line passes through on the fishing bobber device 510.

Another further preferred embodiment fishing bobber device 610 according to the present invention is shown in FIGS. 19 and 20. The fishing bobber device 610 is a modified version of the fishing bobber device 510 shown in FIGS. 17 and 18, modified to include a blade portion 614.

The fishing bobber device 610 includes an elongated float portion 612 connected to a blade portion 614. The blade portion 614 is oriented along a length axis of the elongated float portion 612, preferably a central length axis of the elongated float portion 612. Alternatively, the blade portion 614 is set slightly off angle relative to a length axis of the elongated float portion 612. The float portion 612 is provided with a plurality of tube sections 650 extending transversely across the width of the float portion 612. In this preferred embodiment, the blade portion 614 enhances the amount of directional force exerted by the fishing bobber device 610 on the fishing line extending there through. Again, the amount of directional force can be varied depending on which particular tube section 650 the fishing line is threaded through during operation thereof.

The fishing bobber devices 510 and 610, and some of the other preferred embodiments disclosed, preferably utilize a plug-type line stop 652, as illustrated in FIG. 21. The line stop 652 releasably secures the fishing line 19 to one of the tube sections 650 selected. This sets the length of the fishing line 19 extending from the fishing bobber device to the hook (i.e. sets the depth of the hook below the surface of the water). A loop L is provided between the tube section 650 and the line stop 652 prior to inserting the line stop 652 into the tube section 650. The loop L gets trapped between the outer surface of the plug portion 653 of the line stop 652 and the inner surface of the tube section 650 to releasably lock the fishing line 19 relative to the tube section 650, and thus the fishing bobber device 610. When a fish is hooked and the fishing line 19 is pulled on using the fishing pole by the fisherman, the fishing line 19 pulls out the line stop 652 from the tube section 650 allowing the line stop 652 and the tube section 650, and in turn the fishing bobber device 610, to freely slide relative to the fishing line 19. In this manner, the freely moving fishing bobber device 610 does not interfere with the fishing line 19 during catching the fish using the fishing line 19. Once the fish is caught and/or released, the fisherman resets the line stop 652 to set the desired depth of the hook relative to the fishing bobber device 610, and thus the surface of the water.

Another even further preferred embodiment of the fishing bobber device 710 according to the present invention is shown in FIGS. 23-25.

The fishing bobber device 710 includes a tapered elongated float portion 712 connected to a blade portion 714. The blade portion 714 is oriented along a length axis of the elongated float portion 712. The float portion 712 includes a front tapering float portion 712a extending to a rear cylindrical float portion 712b. The front of the float portion 712 is provided with a beveled front portion 712c, which functions like a water ski to raise the fishing bobber device 710 out of the water as the speed relative to the surface of the water is increased (i.e. upward pressure on beveled front portion 712c increases with speed).

In this embodiment, the blade portion 714 is provided with a weight 754 (e.g. crimp-type lead weight) to maintain the blade portion 714 in a downward position into the water during operation of the fishing bobber device 710. The fishing bobber device 710 is provided with a plurality of tube sections 750 for accommodating the fishing line transversely through the width of the float portion 712. As shown in FIG. 25, the length of the three (3) tube sections 750 slightly increase with the tapering of the front float portion 712a.

The operation of the fishing bobber device 710 is shown in FIG. 26. The fishing bobber device 710 partially floats above the water surface WS and partly below the water surface WS as shown. The fishing line 19 is releaseably secured to the fishing bobber device by the line stop 752. Again, when a fish is hooked on the hook H the fishing line 19 is pulled to release the line stop 752 to allow the fishing bobber device 710 to freely move along the fishing line 19. The fishing line is shown threaded through the center tube section 750; however, the fishing line can be threaded through one of the other tube sections 750. The weight 754 maintains the blade portion 714 down below the water surface WS so that the blade portion 714 can generate a directional force to move the fishing bobber device 710 in a direction off angle relative to the direction of movement of the water or boat. As shown in FIG. 27, a force diagram indicates the forces being applied to the fishing bobber device 710 during operation thereof. The forces (F_{B}—force applied by boat on the fishing line 19, F_{W}—force applied by fishing weight on the fishing line 19) generate a torsion force in a right hand spiral direction causing the fishing bobber device 710 to spin slightly clockwise increasing the angle of incidence on the blade portion 714 relative to the direction of movement of the fishing bobber device 710 increasing the amount of direction force F_{D}. Thus, the tube section 715 being oriented substantially transversely across the width of the float portion 712 places the forces F_{B} and F_{W} a spaced apart distance from the center of gravity of the fishing bobber device 710 or the center of directional force F_{D} (i.e. center of directional force generated by both elongated float portion 712 and blade portion 714) to generate a resulting torsion force on the fishing bobber device 710. The direction of the directional force generated by the fishing bobber device 710 during operation can be reversed by threaded the fishing line 19 though the opposite side of the float portion 712 to provide reversibility of operation. It is noted that the angle of the tube section 750 relative to a length axis of the elongated float portion 712 can be varied so that either more or less torsion force can be applied by the fishing line 19 onto the fishing bobber device 710. Specifically, the tube section 750 can be located at an angle (e.g. 45 degrees) relative to a longitudinal axis of the fishing bobber device 710 to neutralize or increase the directional force depending on orientation.

I claim:

1. A fishing bobber device for use on a fishing line extending into water being fished, said device comprising:
an elongated float portion; and
at least one connection portion for connecting said fishing bobber device to the fishing line.

2. A fishing bobber device for use on fishing line extending into water, said device comprising:
an elongated float portion having at least one passageway extending through said elongated float portion for accommodating the fishing line; and
at least one fin portion extending downwardly from said elongated float portion to impart a directional force on said fishing bobber device when said fishing bobber device is moving relative to the water.

3. A fishing bobber device for use on fishing line extending into water being fished, said device comprising:
an elongated float portion having at least one passageway extending through said elongated float portion for accommodating the fishing line; and
a fin portion extending outwardly and downwardly from said elongated float portion to impart a directional force on the fishing line when said fishing bobber device is moving relative to the water, said fin portion being a blade oriented along a length axis of said elongated float portion.

4. A device according to claim 1, wherein said float portion is a rod-shaped float portion.

5. A device according to claim 4, wherein said float portion is made of Styrofoam material.

6. A device according to claim 5, wherein said elongated float portion is a molded Styrofoam article having an elongated shape in one plane and round shaped in a second perpendicular plane.

7. A device according to claim 1, wherein said connection portion is a passageway extending through said elongated float portion for accommodating the fishing line.

8. A device according to claim 7, wherein said passageway is located transversely relative to a length axis of said elongated float portion.

9. A device according to claim 1, wherein said elongated float portion and said fin portion are configured to both generate a sideways directional force.

10. A device according to claim 1, including a line lock for setting said fishing bobber device on the fishing line.

11. A device according to claim 7, wherein said passageway extends from one side of said elongated float portion to an opposite side thereof.

12. A device according to claim 1, wherein said at least one fin is a plurality of fins.

13. A device according to claim 1, wherein said at least one fin is a single blade.

14. A device according to claim 1, wherein said at least one fin is multiple blades.

15. A device according to claim 13, wherein said blade is fitted in a slot in said elongated float portion.

16. A device according to claim 13, wherein said blade is set at an angle relative to a central axis of said elongated float portion.

17. A device according to claim 15, wherein one side of said blade is connected to said float portion, and an opposite side of said blade extends outwardly and downwardly from said float portion.

18. A device according to claim 7, wherein at least one guide for the fishing line is disposed within said passageway of said elongated float portion.

19. A device according to claim 18, wherein said guide is a plastic tube section.

20. A device according to claim 13, wherein said elongated float portion is a molded Styrofoam article and said blade is a separate blade having an edge received within a slot in said Styrofoam elongated float portion.
